(19) United States
(12) Patent Application Publication
(10) Pub. No.: US 2026/0159386 A1
(43) Pub. Date: Jun. 11, 2026

(54) Method And System For Purifying Hydrogen-Containing Gas

(71) Applicants: Hyundai Motor Company, Seoul (KR); Kia Corporation, Seoul (KR)

(72) Inventor: Jae Uk Shin, Hwaseong-Si (KR)

(21) Appl. No.: 19/180,402

(22) Filed: Apr. 16, 2025

(30) Foreign Application Priority Data
Nov. 18, 2024 (KR) 10-2024-0164577

(51) Int. Cl. C01B 3/56

(52) U.S. Cl. CPC C01B 3/56; C01B 2210/0021; C01B 2210/0062

(57) ABSTRACT

A method for purifying hydrogen-containing gas is introduced. The method may comprise producing hydrogen by removing at least a portion of moisture from hydrogen-containing gas, wherein the removed moisture is adsorbed by an adsorbent. The method may further comprise reducing partial pressure of the moisture adsorbed by the adsorbent, increasing a temperature of the adsorbent after reducing the partial pressure, and regenerating the adsorbent based on increasing the temperature. The method may also include cooling the regenerated adsorbent and supplying the cooled adsorbent to at least one adsorption tower among a plurality of towers.

### CROSS-REFERENCE TO RELATED APPLICATION

This application claims the benefit of priority to Korean Patent Application No. 10-2024-0164577, filed in the Korean Intellectual Property Office on Nov. 18, 2024, the entire contents of which are incorporated herein by reference.

### TECHNICAL FIELD

The present disclosure relates to a method and a system for purifying hydrogen-containing gas by reducing partial pressure of moisture in an adsorbent when regenerating the adsorbent to reduce energy consumption, and by reducing a swing time between adsorption and desorption to improve purifying efficiency.

### BACKGROUND

The matters described in this Background section are only for the enhancement of understanding of the background of the disclosure, and should not be taken as acknowledgment that they correspond to prior art already known to those skilled in the art.

Among the manners to produce hydrogen gas, a water electrolysis manner, which is an electro-chemical converting manner, may be used to decompose water (H₂O) into hydrogen (H₂) and oxygen (O₂). Hydrogen gas produced through the water electrolysis manner may contain water or various foreign substances in larger amount. Accordingly, the water and the foreign substances need to be additionally purified. An adsorption purification manner may be used as such purification manner. The purification manner may include Pressure Swing Adsorption (PSA) based on differences in adsorption capacity of various types of adsorbents depending on pressure, Vacuum Swing Adsorption (VSA), Vacuum Pressure Swing Adsorption (VPSA), and Temperature Swing Adsorption (TSA) based on the difference in adsorption capacity of the adsorbent depending on a temperature. In particular, the hydrogen-containing gas may be purified through TSA, when hydrogen gas produced exhibits lower pressure due to the characteristics of specifications of a water electrolyte stack, and when a non-purge type process may be employed to increase the production yield of the hydrogen gas.

The TSA may include an adsorption process to purify the hydrogen-containing gas by removing moisture in the hydrogen-containing gas, and a regeneration process to regenerate the adsorbent by removing the moisture adsorbed to the adsorbent through a heating process. The TSA may include a purge type TSA which is to regenerate the adsorbent by feeding the hydrogen-containing gas after heating the hydrogen-containing gas serving as the source material, and to discharge purge gas used for regeneration. Although the purge type TSA may use a simpler process, the purge type TSA may degrade the efficiency of hydrogen production by discharging cleaning gas containing hydrogen to the outside.

Anon-purge type TSA, which may reuse the hydrogen-containing cleaning gas used to regenerate the adsorbent, may exhibit hydrogen production efficiency better than that of the purge type TSA by reusing the hydrogen-containing cleaning gas, but may require a complicated process. In addition, as the non-purge type TSA may take longer time to heat the adsorbent for regeneration and cool the adsorbent for adsorption after regeneration of the adsorbent, such that the swing time between the adsorption and the desorption may be increased.

Accordingly, a method and a system for purifying hydrogen-containing gas exhibiting excellent purification efficiency by reducing the swing time between adsorption and desorption are considered.

### SUMMARY

The present disclosure has been made to solve the above-mentioned problems.

According to the present disclosure, a method for purifying hydrogen-containing gas, the method may comprise producing hydrogen by removing at least a portion of moisture from hydrogen-containing gas, wherein the removed moisture is adsorbed by an adsorbent, reducing partial pressure of the moisture adsorbed by the adsorbent, after the reducing of the partial pressure, increasing a temperature of the adsorbent, regenerating, based on the increasing the temperature, the adsorbent, cooling the regenerated adsorbent, and supplying the cooled adsorbent to at least one adsorption tower among a plurality of towers.

The method, wherein the producing hydrogen is performed by the at least one adsorption tower among the plurality of towers, and wherein the reducing the partial pressure, the increasing the temperature, the regenerating the adsorbent, and the cooling the regenerated adsorbent are performed in another tower different from the at least one adsorption tower.

The method, wherein the increasing the temperature of the adsorbent may comprise preheating the hydrogen-containing gas, and wherein the regenerating the adsorbent may comprise regenerating the adsorbent by discharging the preheated hydrogen-containing gas to the adsorbent.

The method may further comprise cooling the discharged hydrogen-containing gas, performing gas-liquid separation for the cooled hydrogen-containing gas to obtain a gas phase, and supplying the gas phase to the adsorbent.

The method, wherein the supplying the gas phase may comprise cooling the gas phase, and supplying the cooled gas phase to the adsorbent.

The method, wherein the cooling the regenerated adsorbent may comprise discharging the hydrogen-containing gas to the regenerated adsorbent.

The method may further comprise cooling the discharged hydrogen-containing gas, performing gas-liquid separation for the cooled hydrogen-containing gas to obtain a gas phase, and supplying the gas phase to the adsorbent.

The method, wherein the supplying the gas phase may comprise cooling the gas phase, and supplying the cooled gas phase to the adsorbent.

According to the present disclosure, a system for purifying hydrogen-containing gas, the system may comprise a plurality of towers configured to swing between adsorption mode of operation and desorption mode of operation, wherein at least one first tower of the plurality of towers operates in the adsorption mode for removing at least a portion of moisture from the hydrogen-containing gas, wherein the removed moisture is adsorbed by an adsorbent, and wherein at least one second tower of the plurality of towers operates in the desorption mode for regenerating a second adsorbent, a heater connected to the at least one second tower for increasing a temperature of the second adsorbent to release the adsorbed moisture from the second adsorbent, a vacuum pump connected to the at least one second tower for reducing partial pressure of the moisture in the second adsorbent, and a plurality of valves configured to control the swing between the adsorption mode of operation and the desorption mode of operation.

The system, wherein the at least one first tower is configured to perform a purification operation by adsorbing the at least the portion of moisture from the hydrogen-containing gas, and wherein the at least one second tower is configured to regenerate the second adsorbent by removing at least a portion of the adsorbed moisture from the second adsorbent.

The system may further comprise a first heat exchanger configured to cool the hydrogen-containing gas discharged from the at least one second tower, which regenerates the second adsorbent, wherein the first heat exchanger is placed between the vacuum pump and the plurality of towers.

The system may further comprise a gas-liquid separator configured to perform gas-liquid separation for the hydrogen-containing gas to obtain a gas phase, wherein the hydrogen-containing gas is cooled and discharged from the first heat exchanger, and supply the gas phase to the vacuum pump.

The system may further comprise a second heat exchanger configured to cool the hydrogen-containing gas discharged from the vacuum pump, and supply the cooled hydrogen-containing gas to the at least one first tower, which performs the purification operation.

The system, wherein the at least one first tower operates in the desorption mode when the at least one second tower operates in the adsorption mode.

The system, wherein the heater is configured to preheat the hydrogen-containing gas.

The system, wherein the at least one second tower is configured to regenerate the second adsorbent by receiving the preheated hydrogen-containing gas.

The system may further comprise a controller configured to control the plurality of valves to control swing time between the adsorption mode of the at least one first tower and the desorption mode of the at least one second tower.

The system, wherein the vacuum pump is configured to reduce pressure in the at least one second tower to a target pressure that is less than atmospheric pressure.

The system, wherein the gas-liquid separator is configured to separate condensed moisture from the hydrogen-containing gas before supplying the gas phase to the vacuum pump.

The system, wherein the second heat exchanger is configured to control a temperature of the hydrogen-containing gas supplied to the at least one first tower.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of operating flow of a system for purifying hydrogen-containing gas according to an example of the present disclosure, wherein valves are set up for Tower A to operate in an adsorption mode and Tower B to operation in a desorption mode;

FIG. 2 shows an example of operating flow of a system for purifying hydrogen-containing gas with a second heat exchanger according to an example of the present disclosure;

FIG. 3 shows another example of operating flow of the system shown in FIG. 1, wherein the valves are set up differently from FIG. 1;

FIG. 4 shows an example of operating flow of a system for purifying hydrogen-containing gas with a first heat exchanger and a gas-liquid separator according to an example of the present disclosure;

FIG. 5 shows an example of operating flow of a system for purifying hydrogen-containing gas with a first heat exchanger, a second heat exchanger, and a gas-liquid separator according to an example of the present disclosure;

FIG. 6 shows another example of operating flow of the system shown in FIG. 5, wherein the valves are set up differently from FIG. 5; and

FIG. 7 shows an exemplary graph of the change in adsorption amount as a function of pressure and a temperature.

### DETAILED DESCRIPTION

The present disclosure will be described in detail below.

Herein, when a certain portion “includes” a certain component, this means that the certain portion may further include other components without excluding said other components unless otherwise stated.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Herein, when a first member is located on a “surface”, “one surface”, “the other surface” or “both surfaces” of a second member, this includes not only a case in which the first member is in contact with the second member, but also a case in which a third member exists between the two members.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hydrogen fuel production process, particularly through electrolysis, may generate hydrogen mixed with water vapor, requiring efficient purification to meet fuel cell standards. Temperature Swing Adsorption (TSA) methods may use an adsorbent material (e.g., activated carbons, zeolites, metal-organic frameworks (MOFs), etc.) to trap water, followed by a heating phase to desorb the moisture, and a cooling phase to reset the process. However, TSA may suffer from high energy consumption and long cycle times (e.g., 4-8 hours per switch), limiting efficiency. The present disclosure introduces Temperature-Vacuum Swing Adsorption (TVSA), integrating a vacuum pump into the desorption phase. By reducing the internal pressure, the vacuum pump may lower the water vapor partial pressure, allowing water removal at lower temperatures compared to TSA methods. TVSA may significantly reduce energy consumption, shorten swing time, and improve hydrogen purification efficiency. Further, reducing thermal gradients may mitigate hot spot issues in adsorbents, increasing their durability.

### Purifying Method

A method (hereinafter, a purifying method) for purifying hydrogen-containing gas according to the present disclosure is to purify the hydrogen-containing gas, for example, through Temperature Vacuum Swing Adsorption (TVSA). In addition, the purifying method includes the steps for purifying (S10; purifying step), for reducing pressure (S20; pressure reducing step), for regenerating an adsorbent (e.g., one of various types of adsorbents such as activated carbons, zeolites, metal-organic frameworks (MOFs), etc.) (S30; adsorbent regenerating step), and for cooling (S40; cooling step).

According to a manner for producing hydrogen, the partial pressure of moisture in the adsorbent having moisture adsorbed thereto may be reduced to lower latent heat when the adsorbent is regenerated, thereby reducing the energy consumption necessary for the regenerating of the adsorbent.

For example, purifying step (‘S10’) is performed in at least one tower (e.g., an adsorption tower or a tower operating in an adsorption mode at a given swing time or cycle) among a plurality of towers, reducing pressure step (‘S20’), adsorbent regeneration step (‘S30’), and cooling step (‘S40’) may be performed in another tower other (e.g., a desorption tower or a tower operating in a desorption mode at a given swing time or cycle) than the adsorption tower used for performing the purifying step (‘S10’).

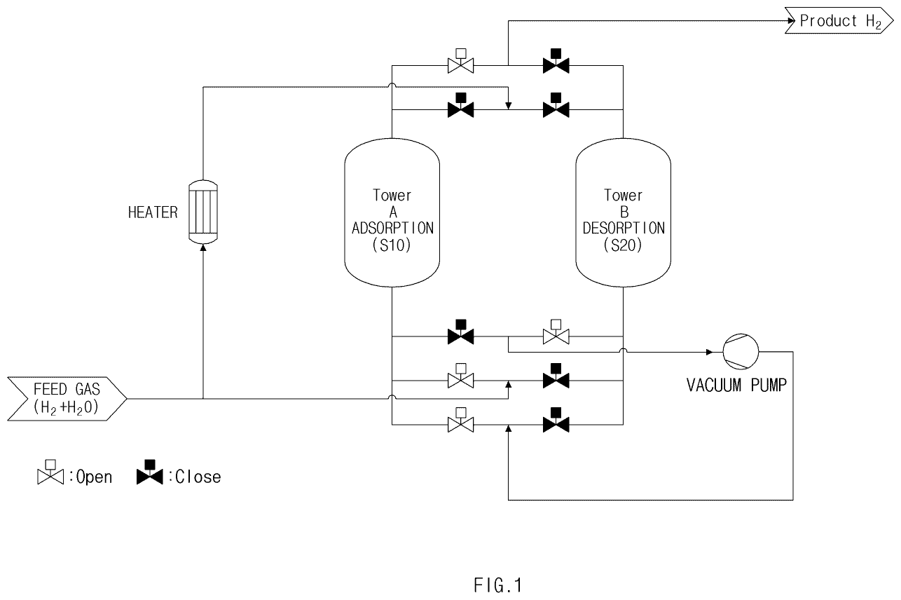

In detail, referring to FIG. 1, the purifying method may be performed using at least one adsorption tower (e.g., Tower A), which is to perform the purifying step (S10), and another tower (e.g., Tower B operating in the desorption mode at a given swing time or cycle), which is to perform the pressure reducing step (S20), the adsorbent regenerating step (S30), and the cooling step (S40), among the plurality of towers filled therein with the adsorbent.

### Purifying Step (S10)

In the purifying step, impurities, including moisture or other contaminants, in the hydrogen-containing gas is adsorbed to the adsorbent to produce hydrogen.

The hydrogen-containing gas is not specifically limited, as long as the hydrogen-containing gas includes water and foreign substances (e.g., water, carbon dioxide, nitrogen, or hydrocarbons, etc.), and is purified to produce hydrogen gas. For example, the hydrogen-containing gas may be produced through the water electrolysis manner, but the present disclosure is not limited thereto. For example, the hydrogen-containing gas may include syngas (a mixture of hydrogen, carbon monoxide, and carbon dioxide), reformate gas from steam methane reforming, hydrogen-rich gas from water electrolysis, off-gas from industrial processes, cracked ammonia gas (a mixture of hydrogen and nitrogen), or fuel cell exhaust containing unreacted hydrogen.

The adsorbent is not specifically limited thereto, as long as the adsorbent is used to adsorb and separate the hydrogen gas from the mixed gas. For example, the adsorbent may include a variety of materials designed for adsorption such as inorganic or organic porous particles, such as silica gel, activated carbon, metal-organic frameworks, alumina, or zeolite.

The temperature in the purifying step is not specifically limited thereto, as long as the temperature is applicable to adsorbing, separating, and purifying the hydrogen gas from the mixed gas using the adsorbent. Since a purification reaction based on adsorption may be an exothermic reaction, the temperature in the purifying step may be generally controlled to ensure effective adsorption. The temperature may be, for example, a room temperature, specifically, ranging from 6° C. to 30° C.

### Pressure Reducing Step (S20)

The partial pressure of moisture in the adsorbent, which has the adsorbed moisture and needs to be regenerated, is reduced in the pressure reducing step (S20), thereby reducing energy consumption necessary for regenerating by reducing the latent heat when the adsorbent is regenerated.

Referring to FIG. 1, the pressure reducing step may involve adjusting system pressure dynamically by reducing the pressure of a tower (e.g., Tower B operating in the desorption mode) filled with the adsorbent, using a vacuum pump.

In this case, target pressure is not specifically limited thereto. For example, the target pressure may vary depending on process conditions. The target pressure may be less than atmospheric pressure, and may be less than 1 bar (e.g., specifically less than 1 bar, at most 0.8 bar, at most 0.5 bar, or at most 0.2 bar). As the target pressure is in the above range, the partial pressure of moisture in the adsorbent is reduced and the temperature for regenerating the adsorbent is reduced, thereby reducing the energy consumption.

The gas discharged from the adsorbent in the reducing pressure step (‘S20’) may be fed back to the purifying step (‘S10’). In other words, the gas, which is discharged from the tower by the vacuum pump to reduce the partial pressure of moisture in the adsorbent, may be fed back to the purifying step (S10) to produce purified hydrogen.

For example, the purifying method may include the steps for cooling the gas, which is discharged in the reducing pressure step (‘S20’), (S21), and for feeding the gas, which is cooled in the cooling step (‘S21’), back to the purifying step (‘S10’) (S22).

The cooling in the cooling step (‘S21’) may improve the adsorption efficiency by reducing the temperature of gas heated by heat emitted from the vacuum pump operated to reduce the partial pressure of moisture in the adsorbent.

In addition, the cooling in the cooling step (‘S21’) is to allow the temperature of gas discharged in the reducing pressure step (‘S20’) to be at most 35° C. or at most 30° C., but the present disclosure is not limited thereto. When the temperature of the gas in cooling is at most 35° C. or at most 30° C., an amount of vapor contained in the gas may be reduced such that the amount of vapor to be processed in the purifying step is reduced.

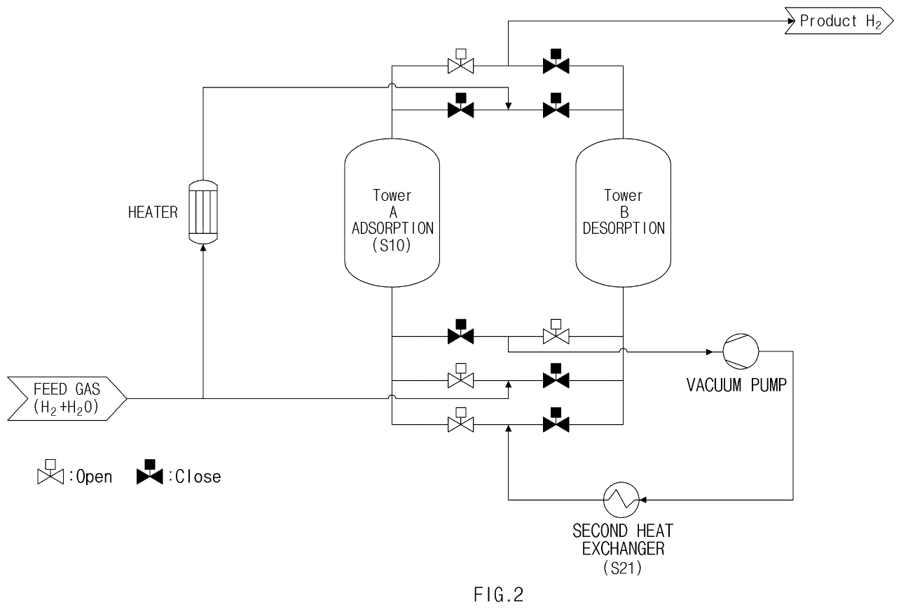

Referring to FIG. 2, the cooling step (‘S21’) may be performed using a second heat exchanger (e.g., a shell-and-tube heat exchanger, plate heat exchanger, or air-cooled heat exchanger, etc.). In detail, the purifying method may include the pressure reducing step (S20) to reduce the partial pressure of moisture in the adsorbent having the moisture adsorbed thereto, the step for cooling the gas discharged in ‘S20’ (S21), and the step for directing the cooled gas from in the cooling step (‘S21’) back into the purifying step (‘S10’), which may include, for example, additional filtration or moisture separation before reintroduction to enhance purification efficiency.

### Adsorbent Regenerating Step (S30)

In the adsorbent regenerating step (S30), the temperature of the adsorbent, previously processed (e.g., pressure reduction) in S20, is increased (e.g., using resistive heaters, steam heating, or infrared-based thermal sources, etc.) and the adsorbent is regenerated (e.g., moisture desorption).

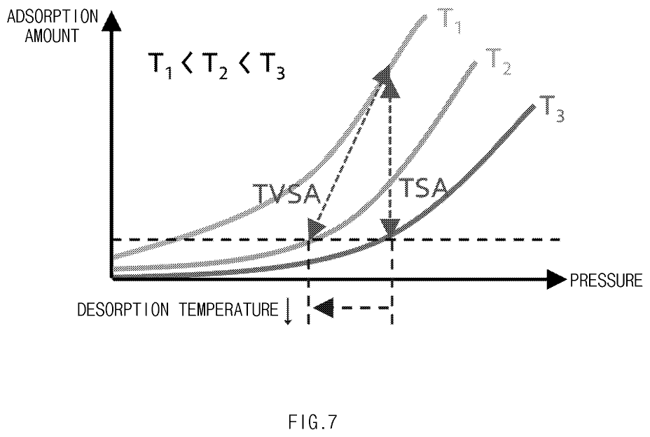

Cleaning gas heated to about 220° C. may be used for regeneration of the absorbent. The target temperature for regeneration may range from 100° C. to 200° C. (e.g., at most 200° C., at least 100° C., at least 120° C., or at most 180° C.), which is lower than the temperature required for generation of the adsorbent according to the TSA. In detail, as illustrated in FIG. 7, according to the present disclosure (TVSA), the partial pressure of moisture in the adsorbent becomes lower than that of the TSA. Accordingly, the calorie necessary in regenerating the adsorbent is reduced and even the temperature necessary for regenerating is reduced. As described above, according to the present disclosure, the adsorbent is regenerated at a temperature lower than that in regenerating the adsorbent according to the TSA, thereby reducing the energy consumption necessary for regenerating the adsorbent.

In detail, the increasing of the temperature and the regenerating of the adsorbent in S30 may include the steps for preheating the hydrogen-containing gas (S31) (e.g., using electrical resistance heating, catalytic combustion, or indirect heat exchange, etc.) and regenerating the adsorbent by feeding the hydrogen-containing gas, which is preheated in ‘S31’, to the adsorbent.

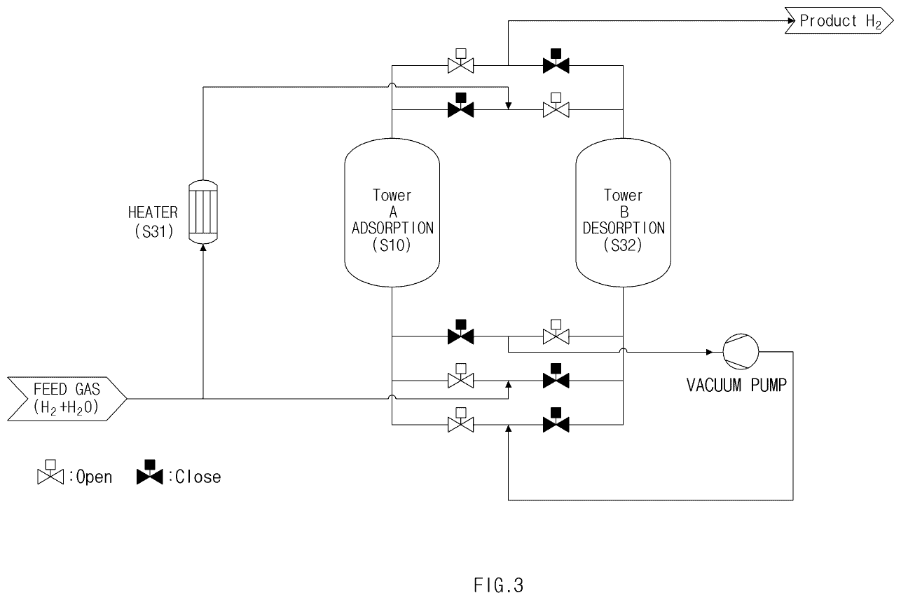

The preheating in the preheating step (‘S31’) may be performed using, for example, a heater, which may be a convection heater, an infrared heating unit, or a gas-fired system. Referring to FIG. 3, the increase in the temperature may be achieved by introducing a preheated gas stream (e.g., hydrogen-containing gas, inert gases such as nitrogen, or a combination thereof) to the adsorbent using the heater.

The temperature for the preheating is not specifically limited, as long as the temperature is applicable to removing adsorbed moisture from the adsorbent. For example, the temperature may range from, for example, 100° C. to 200° C. (e.g., at most 200° C., at least 100° C., at least 120° C., or 180° C.). The temperature for the preheating may be lower than the temperature used for regeneration of the adsorbent according to the TSA.

Optionally, the preheating step (S31) may include multiple heating stages, where an initial heating stage may raise the temperature gradually to prevent adsorbent damage or thermal shock. In this step, a heat exchanger or resistance heating element may be used to ensure uniform temperature distribution. Furthermore, the heated gas introduced for regeneration may be also adjusted based on real-time monitoring of the moisture content within the adsorbent. Optionally, a feedback control mechanism, such as a temperature sensor or moisture analyzer, may be integrated into the process to improve energy efficiency.

The adsorbent regenerating step may include the steps for cooling the hydrogen-containing gas discharged in ‘S32’ (S33), performing gas-liquid separation for the hydrogen-containing gas which is cooled in the cooling step (‘S33’) (S34), and feeding a gas phase, which is obtained through the gas-liquid separation, to the purifying step (‘S10’) (S35).

The cooling in ‘S33’ is to reduce the temperature of the hydrogen-containing gas preheated to regenerate the adsorbent, thereby easily removing moisture contained in the hydrogen-containing gas.

In addition, the cooling in ‘S33’ is to control the temperature of the hydrogen-containing gas to be ranging from 100° C. to 200° C. (e.g., at most 200° C., at least 100° C., at least 120° C., or at most 180° C.), but the present disclosure is not limited thereto. If the temperature in cooling is less than or equal to the range of temperature, an amount of vapor contained in the gas may be reduced such that the amount of vapor to be processed in the purifying step is reduced.

The ‘S34’ is applicable without specific limitation, as long as the step for performing the gas-liquid separation in ‘S34’ is applicable to separating the gas phase from the gas-liquid mixture. For example, ‘S34’ may be performed using a gas-liquid separator (e.g., a cyclone separator, gravity separator, wire mesh mist eliminator, coalescing separator, vane-type separator, or a membrane separator, etc.). In addition, a larger amount of moisture may be prevented from being introduced into the vacuum pump provided to reduce the pressure due to the gas-liquid separation.

In addition, the gas phase obtained through the separation in ‘S34’ may be fed to the purifying step ‘S10’, and a liquid phase obtained through the gas-liquid separation may be discharged to the outside. In other words, according to the purifying method, excellent efficiency may be exhibited in hydrogen production by reusing the cleaning gas used to regenerate the adsorbent, which is similar to a non-purge type TSA.

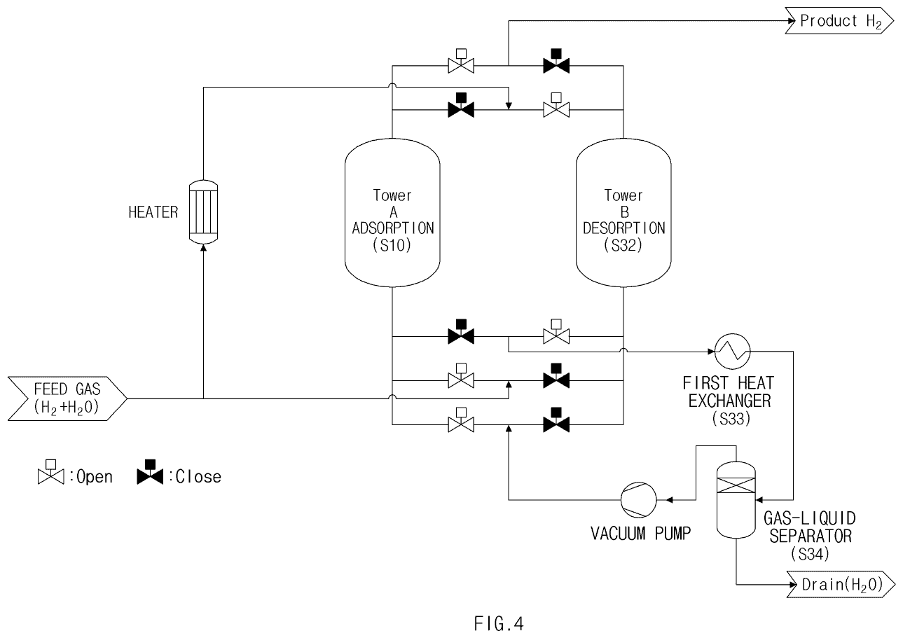

Referring to FIG. 4, the adsorbent regenerating step may include multiple steps such as preheating or gradually preheating the hydrogen-containing gas or an alternative gas, such as a hydrogen-inert gas mixture (S31), regenerating the adsorbent by discharging the preheated gas to the adsorbent(S32), cooling process to control the temperature of the discharged hydrogen-containing gas in the regenerating step (‘S32’) (S33), for example, by passing the discharged gas through a heat exchanger, performing gas-liquid separation step for the cooled hydrogen-containing gas(S34), and feeding the gas phase, which is obtained through the gas-liquid separation process, to the purifying step (‘S10’) (S35). In this case, the cooling in the cooling step (‘S33’) may be performed using a heat exchanger (e.g., a shell-and-tube exchanger, plate heat exchanger, or air-cooled heat exchanger, finned-tube heat exchanger, spiral heat exchanger, phase-change heat exchanger, etc.), and ‘S34’ may be performed using the gas-liquid separator (e.g., a cyclone separator, gravity separator, wire mesh mist eliminator, coalescing separator, vane-type separator, or a membrane separator, etc.).

The feeding the gas phase step (‘S35’) may include the steps for cooling a gas phase obtained through the gas-liquid separation step(‘S34’) (S35-1) and feeding the cooled gas phase back to the purifying step (‘S10’) (S35-2).

The cooling in the gas-liquid separation step (‘S35-1’) may increase the adsorption efficiency by lowering the temperature of the gas phase obtained through the gas-liquid separation.

In addition, the cooling in the gas-liquid separation step (‘S35-1’) is to control the temperature of the gas phase to be ranging from 100° C. to 200° C. (e.g., at most 200° C., at least 100° C., at least 120° C., or at most 180° C.), but the present disclosure is not limited thereto. If the temperature in cooling is less than or equal to the range of temperature, an amount of vapor contained in the gas may be reduced such that an amount of vapor to be processed in the purifying step is reduced.

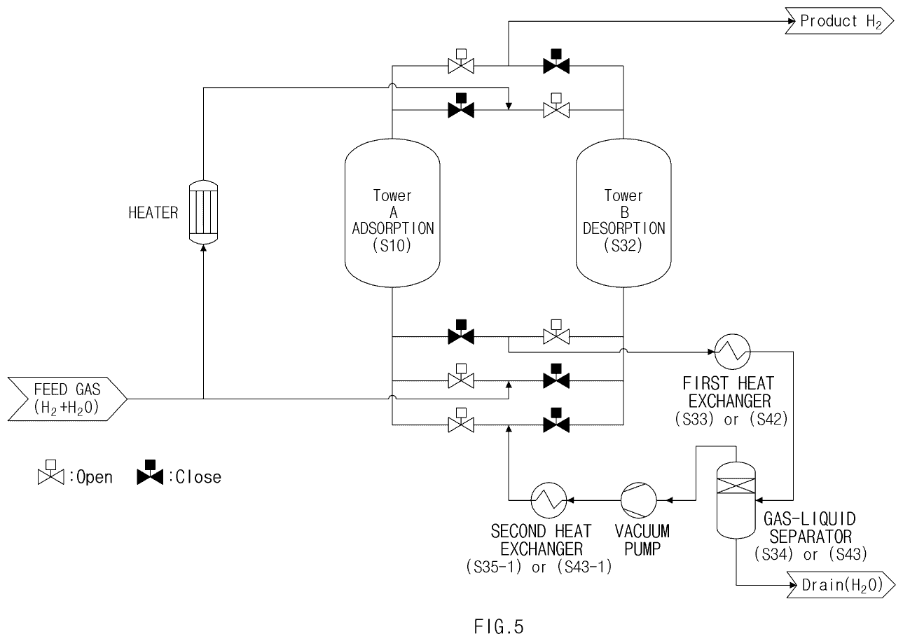

Referring to FIG. 5, the adsorbent regenerating step may include the steps for preheating or gradually preheating the hydrogen-containing gas or an alternative gas, such as a hydrogen-inert gas mixture (S31), regenerating the adsorbent by feeding or discharging the preheated hydrogen-containing gas to the adsorbent (S32), for example, in a controlled manner to ensure uniform heating, cooling the discharged hydrogen-containing gas in ‘S32’ (S33), for example, through a heat exchanger to control the temperature and improve condensation efficiency, performing gas-liquid separation for the cooled hydrogen-containing gas (S34), cooling the gas phase obtained through the gas-liquid separation (S35-1) and feeding the cooled gas phase to the purifying step (‘S10’) (S35-2). In this case, each of the cooling in ‘S33’ and ‘S35-1’ may be performed using a heat exchanger (e.g., a shell-and-tube exchanger, plate heat exchanger, or air-cooled heat exchanger, finned-tube heat exchanger, spiral heat exchanger, phase-change heat exchanger, etc.), and ‘S34’ may be performed using the gas-liquid separator (e.g., a cyclone separator, gravity separator, wire mesh mist eliminator, coalescing separator, vane-type separator, or a membrane separator, etc.).

### Cooling Step (S40)

The ‘S40’ may cool the adsorbent regenerated in the adsorbent regenerating step to improve the adsorption efficiency of the adsorbent.

For example, ‘S40’ may include feeding the hydrogen-containing gas (e.g., a mixture of hydrogen, carbon monoxide, and carbon dioxide, reformate gas from steam methane reforming, hydrogen-rich gas from water electrolysis, off-gas from industrial processes, cracked ammonia gas, or fuel cell exhaust containing unreacted hydrogen, etc.) to the adsorbent, which is regenerated at regenerating step (S41). As shown in FIG. 2, the hydrogen-containing gas, which serves as a source material, may be fed to the adsorbent regenerated and cooled. In this case, the heater does not operate.

In addition, the cooling step may include the steps of cooling the hydrogen-containing gas discharged in the regenerating step (‘S41’) (S42), performing gas-liquid separation for the hydrogen-containing gas which is cooled in the regenerating step (‘S42’) (S43), and feeding or discharging a gas phase, which is obtained through the gas-liquid separation in ‘S43’, back to the purifying step (‘S10’) (S44).

Referring to FIG. 4, the cooling step may include the steps for feeding or discharging the hydrogen-containing gas to the adsorbent, which is regenerated, and cooling the adsorbent (S41), cooling the hydrogen-containing gas discharged in the regenerating step (‘S41’) (S42), performing gas-liquid separation for the hydrogen-containing gas which is cooled (S43), and feeding or discharging a gas phase, which is obtained through the gas-liquid separation, back to the purifying step (‘S10’) (S44).

The discharging the gas phase (‘S44’) may include cooling a gas phase obtained through the gas-liquid separation in the regenerating step (‘S43’) (S44-1) and feeding or discharging the cooled gas phase back to the purifying step (‘S10’) (S44-2).

The cooling in the discharging the gas phase (‘S44-1’) may increase the adsorption efficiency by lowering the temperature of the gas phase obtained through the gas-liquid separation.

In addition, the cooling in the discharging the gas phase (‘S44-1’) is to control the temperature of the gas phase to be ranging from 100° C. to 200° C. (e.g., at most 200° C., at least 100° C., at least 120° C., or at most 180° C.), but the present disclosure is not limited thereto. If the temperature in cooling is less than or equal to the range of temperature, an amount of vapor contained in the gas may be reduced such that an amount of vapor to be processed in the purifying step is reduced.

Referring to FIG. 5, the cooling step may include the steps for feeding the hydrogen-containing gas to the adsorbent, which is regenerated, and cooling the adsorbent (S41), cooling the hydrogen-containing gas discharged in the cooling the adsorbent (‘S41’) (S42), performing gas-liquid separation for the hydrogen-containing gas which is cooled (S43), cooling the gas phase which is obtained through the gas-liquid separation (S44-1), and feeding a gas phase, which is cooled, to the purifying step (‘S10’) (S44-2). In this case, each of the cooling in the cooling the hydrogen-containing gas discharged (‘S42’) and in the gas-liquid separation (‘S44-1’) may be performed using a heat exchanger (e.g., plate heat exchanger or air-cooled heat exchanger), and gas-liquid separation for the hydrogen-containing gas (‘S43’) may be performed using the gas-liquid separator (e.g., a cyclone separator or membrane separator).

As described above, according to the method for purifying the hydrogen-containing gas, when the adsorbent is regenerated, the partial pressure of moisture in the adsorbent may be reduced to reduce energy consumption, and a swing time between adsorption and desorption may be reduced to improve purifying efficiency. The swing time refers to the adjustable configuration of a plurality of towers (via valves) to alternate between adsorption and desorption modes of operations. In addition, according to the method for purifying the hydrogen-containing gas, excellent efficiency may be exhibited in hydrogen production by reusing the cleaning gas used to regenerate the adsorbent. For example, the cleaning gas may include hydrogen-rich gas used during adsorbent regeneration in hydrogen purification systems, nitrogen gas used as an inert purging agent, air used in low-sensitivity applications to remove contaminants, steam used to clean adsorbents in high-temperature processes, carbon dioxide, or helium, etc.

### System for Purifying Hydrogen-containing Gas

According to the present disclosure, a system (hereinafter, a purifying system) for purifying hydrogen-containing gas is a system to purify hydrogen-containing gas through Temperature Vacuum Swing Adsorption (TVSA). In addition, the purifying system includes a plurality of towers, a heater, and a vacuum pump, and the swing in the plurality of towers is adjusted by a valve. The swing in the plurality of towers refers to alternating operation of the plurality of towers between two primary modes: adsorption and desorption (or regeneration). In the context of a swing adsorption process (e.g., TVSA or TSA), the swing corresponds to a cyclical switching of the towers'functions (adsorption function or desorption function) to ensure continuous operation of the system. For example, one tower (e.g., Tower A) may operate in adsorption mode, where the hydrogen-containing gas flows through the one tower, and the adsorbent removes moisture or impurities from the hydrogen-containing gas. Simultaneously, another tower (e.g., Tower B) may operate in desorption (or regeneration) mode, where the adsorbent is regenerated by removing the adsorbed moisture or impurities, for example, by applying heat, vacuum, or both. After a set time or when the adsorbent in Tower A becomes saturated, the roles of the towers are switched. Tower A that was performing adsorption transitions to desorption mode, and vice versa. This approach allows the adsorbent in one tower to regenerate while the other tower is actively purifying gas. The swing time refers to the adjustable configuration of the towers (via valves) to alternate between adsorption and desorption modes or phases. This flexibility allows the roles of the towers to change dynamically, rather than being permanently fixed.

According to the present disclosure, the purifying system may reduce the partial pressure of moisture in the adsorbent having moisture adsorbed thereto using the vacuum pump, thereby reducing energy consumption necessary for regenerating the adsorbent by reducing the latent heat when the adsorbent is regenerated. In addition, the purifying system maintains the internal pressure of a tower (e.g., Tower B operating in the desorption mode) to be lower using the vacuum pump when the adsorbent is regenerated, thereby reducing energy consumption by reducing the temperature necessary for regeneration (see FIG. 7).

Referring to FIG. 7, the graph shows the relationship between adsorption amount, pressure, and desorption temperature for both the Temperature Vacuum Swing Adsorption (TVSA) process and the Temperature Swing Adsorption (TSA) process. When adsorbed at T₁, the TSA process requires heating to a relatively high temperature of T₃ for desorption, but the TVSA process may enable desorption to the same level even at a significantly reduced temperature T₂. This reduction may be achieved by applying vacuum pressure, which lowers the partial pressure of moisture within the adsorbent, thereby facilitating desorption.

The TVSA process, as shown in FIG. 7, improves energy efficiency by reducing both the heating requirements and the overall desorption time. For example, in hydrogen purification systems, this process may allow for reduced thermal stress on adsorbent materials, such as zeolite or silica gel, which extends their operational lifespan. This improvement is beneficial in systems requiring frequent adsorption-desorption cycles, such as those used for hydrogen drying or moisture removal in industrial gas processing.

The graph further shows that the desorption may be performed at lower temperatures in the TVSA process due to the efficient combination of vacuum and temperature control. As a result, TVSA may provide a more sustainable and cost-effective alternative to the TSA methods.

Referring to FIG. 1, according to the present disclosure, the purifying system may include a heater which is connected to a tower (e.g., Tower A or Tower B operating in the desorption mode) to increase the temperature of the adsorbent and regenerate the adsorbent, a plurality of towers filled with the adsorbent, and a vacuum pump connected to at least one of the plurality of towers to reduce the partial pressure of moisture in the adsorbent, may include a plurality of valves, and may adjust swing in the plurality of towers using the plurality of valves such that one tower may operate in the adsorption mode, where moisture or impurities, from the hydrogen-containing gas flowing through the one tower, is adsorbed by the adsorbent, and another tower may operate in the desorption (or regeneration) mode, where the adsorbent is regenerated by removing the adsorbed moisture or impurities from the adsorbent.

Referring to FIG. 1, the purifying system may include a plurality of towers (e.g., Tower A and Tower B), a heater, and a vacuum pump. Feed gas containing hydrogen and water (H₂+H₂O) enters the purifying system through a network of strategically placed or controlled valves that direct the gas into, for example, Tower A for adsorption. During this phase, Tower A may remove moisture from the feed gas, producing high-purity hydrogen gas (Product H2), which is discharged through an outlet at the top of Tower A.

Tower B may undergo desorption (regeneration), for example, simultaneously with adsorption performed by Tower A, using a combination of heat supplied by the heater and vacuum pressure generated by the vacuum pump. The vacuum pump may reduce the partial pressure of moisture in Tower B, enhancing desorption efficiency and reducing the required desorption temperature. The flow of gases between the towers and the vacuum pump may be controlled by an automated valve system to ensure synchronized operation.

The valve positions (e.g., open or close) may indicate which tower is in the adsorption mode and which is in the desorption mode. For example, Tower A operates in the adsorption mode with its inlet valve and outlet valve open, while Tower B operates in the desorption mode with its valves configured to direct moisture-laden gas to the vacuum pump. This cyclic operation (e.g., swing) may ensure continuous purification of the feed gas.

### Vacuum Pump

The vacuum pump reduces the partial pressure of moisture in the adsorbent to increase the regeneration efficiency of the adsorbent.

Referring to FIG. 1, the purifying system does not feed gas or stop feeding gas by shutting off the valve provided for a tower (e.g., Tower B operating in the desorption mode) to perform regeneration, and may reduce the partial pressure of moisture in the adsorbent using the vacuum pump (e.g., rotary vane vacuum pumps, liquid ring vacuum pumps, dry screw vacuum pumps, diaphragm vacuum pumps, turbo molecular vacuum pumps, scroll vacuum pumps, or ejector vacuum pumps, etc.) to increase the regeneration efficiency of the adsorbent.

In this case, the target pressure is not specifically limited thereto when the pressure is reduced using the vacuum pump. For example, the target pressure may be less than atmospheric pressure, and may be less than 1 bar (e.g., specifically less than 1 bar, at most 0.8 bar, at most 0.5 bar, or at most 0.2 bar). As the target pressure is in the above range, the partial pressure of moisture in the adsorbent is reduced and the temperature in regenerating the adsorbent is reduced. Accordingly, the energy consumption necessary for regeneration is reduced, which may result in cost saving (see FIG. 7).

The gas discharged from the vacuum pump may be fed back to another tower (e.g., Tower A operating in the adsorption mode), which purifies the adsorbent. In other words, the gas discharged from Tower B by the vacuum pump to reduce the partial pressure of moisture in the adsorbent may be fed back to Tower A, which performs purification operation, to produce hydrogen or purified hydrogen.

For example, the purifying system may include a second heat exchanger, as shown in FIG. 2, to cool the hydrogen-containing gas discharged from the vacuum pump and to feed the hydrogen-containing gas back to, for example, Tower A, which performs the purification operation.

### Second Heat Exchanger

The second heat exchanger may improve the adsorption efficiency by reducing the temperature of the hydrogen-containing gas heated by heat emitted from the vacuum pump which is operated to reduce the partial pressure of moisture in the adsorbent. For examples, the second heat exchanger may be shell-and-tube heat exchanger, plate heat exchanger, air-cooled heat exchanger, finned-tube heat exchanger, spiral heat exchanger, phase-change heat exchanger (condensers and evaporators), or double-pipe heat exchanger.

In addition, the second heat exchanger is to control the temperature of the hydrogen-containing gas discharged from the vacuum pump to be ranging from 100° C. to 200° C. (e.g., most 200° C., at least 100° C., at least 120° C., or at most 180° C.), but the present disclosure is not limited thereto. If the temperature in cooling using the second heat exchanger is less than or equal to the range of temperature, an amount of vapor contained in the gas may be reduced such that an amount of vapor to be processed in the purifying step is reduced.

Referring to FIG. 2, the gas discharged from the vacuum pump may be cooled by the second heat exchanger. Specifically, the purifying system may include a tower (e.g., Tower B), which regenerates an adsorbent (e.g., activated carbons, zeolites, metal-organic frameworks (MOFs), etc.), a vacuum pump which reduces the partial pressure of moisture in the tower performing the regeneration, and a second exchanger which cools gas discharged from the vacuum pump. Heater

The heater increases the temperature of the adsorbent.

The heater may receive the hydrogen-containing gas and preheat the hydrogen-containing gas. For example, the heater may be an electric resistance heater, induction heater, infrared heater, hot water or steam heater, plate heater, ceramic heater, or gas-fired heater.

The hydrogen-containing gas containing water and foreign substances is not specifically limited, as long as the hydrogen-containing gas is purified to produce hydrogen gas. For example, the hydrogen-containing gas may be produced through the water electrolysis manner, but the present disclosure is not limited thereto.

Cleaning gas heated to about 220° C. may be used for regeneration of the adsorbent according to the TSA. For regenerating the adsorbent according to the present disclosure, the adsorbent may be regenerated at the temperature ranging from 100° C. to 200° C. (e.g., at most 200° C., at least 100° C., at least 120° C., or at most 180° C.), which is lower than the temperature (e.g., 220° C.) used for regeneration of the adsorbent according to the TSA. In detail, as shown in FIG. 7, according to the present disclosure (TVSA), the partial pressure of moisture in the adsorbent becomes lower than that of the TSA, leading to improved water removal and reduced regeneration time. Accordingly, the energy demand for regenerating the adsorbent is reduced and even the temperature necessary for regenerating is reduced. As described above, according to the present disclosure, the adsorbent is regenerated at a temperature lower than that in regenerating the adsorbent according to the TSA, thereby reducing the energy consumption necessary for regenerating the adsorbent.

When the temperature is increased using the heater, the target temperature is not specifically limited, as long as the target temperature is applicable to removing adsorbed moisture from the adsorbent. For example, the target temperature may be, for example, ranging from 100° C. to 200° C. (e.g., at most 200° C., at least 100° C., at least 120° C., or 180° C.). In other words, the temperature for the preheating may be lower than the temperature in regenerating the adsorbent according to the TSA.

In addition, as the hydrogen-containing gas preheated in the heater may be fed to the adsorbent of a tower (e.g., Tower B operating in the desorption mode), which regenerates the hydrogen-containing gas preheated in the heater, thereby regenerating the adsorbent.

Referring to FIG. 3, the purifying system may include a heater to receive the hydrogen-containing gas and preheat the hydrogen-containing gas, and, for example, Tower B operating in the desorption mode to receive the hydrogen-containing gas preheated in the heater to increase the temperature of the adsorbent and to regenerate the adsorbent.

### Adsorption Tower

An adsorption tower (e.g., one of a tower, among a plurality of towers, operating in an adsorption mode at a given swing time) is filled with the adsorbent for adsorbing at least a portion of moisture (e.g., internal moisture) of the hydrogen-containing gas.

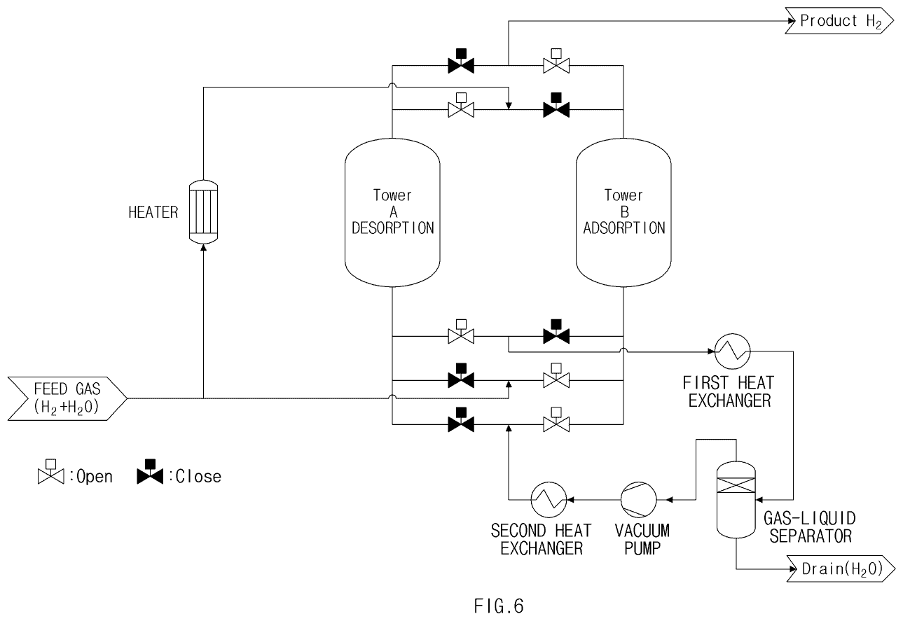

At least one of the plurality of towers may perform a purification operation to adsorb the internal moisture of the hydrogen-containing gas, and another tower other than the at least one tower, which performs the purifying, may operate in a desorption mode to regenerate the adsorbent. Referring to FIG. 6, the swing (e.g., the adsorption-desorption cycle) in the plurality of towers may be adjusted by a valve or a set of values, for example, controlling gas flow direction and operational timing. For example, a series of values may be strategically placed or controlled valves that control the flow of gases, including feed gas, product hydrogen, and purge gases, between the plurality of towers (e.g., Tower A and Tower B).

Referring to FIG. 1 or FIG. 6, Tower A, which is at least one of the plurality of towers filled therein with the adsorbent (e.g., zeolite, silica gel, or activated alumina, etc.), may operate in an adsorption mode to perform a purification operation to adsorb the internal moisture and/or impurities of the hydrogen-containing gas. Tower B, which is another tower other than Tower A, may also perform a purification operation, for example, when Tower A does not perform a purification operation, and, at another time, may operate in a desorption mode to regenerate the adsorbent. The regeneration of the adsorbent (desorption) may be performed by releasing the absorbed moisture through application of heat (via the heater) and vacuum pressure (via the vacuum pump).

The gas discharged during desorption is cooled in the first heat exchanger, and the condensed water is separated in the gas-liquid separator, with the liquid water drained through a dedicated outlet. The gas phase is further cooled in the second heat exchanger before being recycled back into the purifying system to reduce gas losses and improve efficiency. The valve system may ensure a continuous swing operation between at least two towers (e.g., Tower A and Tower B), one operating in the adsorption mode and another operating in the desorption mode, enabling uninterrupted purification of the hydrogen-containing gas.

The purifying system may include a first heat exchanger interposed between at least one of the plurality towers and the vacuum pump or interposed between the at least one of the plurality of towers and a gas-liquid separator. The first heat exchange may be used to cool the hydrogen-containing gas discharged from the at least one tower (e.g., desorption tower or a tower operating in the desorption mode), which regenerates the adsorbent.

### First Heat Exchanger

The first heat exchanger may reduce the temperature of the hydrogen-containing gas, which is preheated, discharged from an adsorption device (e.g., a tower operating in a desorption mode) which regenerates the adsorbent.

In addition, the first heat exchanger may perform a cooling process to control the temperature of the hydrogen-containing gas to be ranging from 100° C. to 200° C. (e.g., at most 200° C., at least 100° C., at least 120° C., or at most 180° C.), but the target temperature is not limited thereto. If the temperature in cooling using the first heat exchanger is less than or equal to the range of temperature, an amount of vapor contained in the hydrogen-containing gas may be reduced such that an amount of vapor to be processed in the purifying step is reduced.

The purifying system may include a gas-liquid separator, as shown in FIG. 4, FIG. 5, and FIG. 6, which performs a gas-liquid separation for the cooled hydrogen-containing gas, which is discharged from the first heat exchanger, and feeds the separated gas phase to the vacuum pump.

### Gas-liquid Separator

The gas-liquid separator performs the gas-liquid separation and feeds only the separated gas phase to the vacuum pump, thereby preventing the damage to the vacuum pump or the efficiency degradation as a larger amount of moisture is introduced into the vacuum pump. For example, the gas-liquid separator may include cyclone separators, which use centrifugal force to separate liquids from gas, knockout drums, which rely on gravity to remove liquids from gas streams, demister pads, which capture fine liquid droplets using mesh or wire screens, membrane separators, which use selective barriers to separate gas and liquid phases, coalescing separators, which merge small liquid droplets into larger ones for easier removal, or vane separators, which use curved blades to separate liquids from gases efficiently.

For example, the gas phase obtained through the separation in the gas-liquid separator may be fed to the vacuum pump, and a liquid phase obtained through the separation may be discharged to the outside. In other words, according to the purifying system, excellent efficiency may be exhibited in hydrogen production by reusing the cleaning gas (e.g., hydrogen-rich gas, nitrogen gas, air, steam, carbon dioxide, or helium, etc.) used to regenerate the adsorbent, which is similar to a non-purge type TSA.

Referring to FIG. 4, the purifying system may include a heater to preheat the hydrogen-containing gas, and a tower (e.g., Tower B operating in the desorption mode) to receive the hydrogen-containing gas preheated in the heater to increase the temperature of the adsorbent and to regenerate the adsorbent, a first heat exchanger to cool the hydrogen-containing gas discharged from, for example, Tower B, which regenerates the adsorbent, a gas-liquid separator which performs a gas-liquid separation for the cooled hydrogen-containing gas discharged from the first heat exchanger and feeds the separated gas phase to a vacuum pump, and the vacuum pump to increase the regeneration efficiency of the adsorbent.

Referring to FIG. 5, the purifying system may include a heater to preheat the hydrogen-containing gas, and a tower (e.g., Tower B operating in the desorption mode) to increase the temperature of the adsorbent and to regenerate the adsorbent by using the preheated hydrogen-containing gas, a first heat exchanger to cool the hydrogen-containing gas discharged from, for example, Tower B operating in the desorption mode, which regenerates the adsorbent, a gas-liquid separator which performs a gas-liquid separation for the cooled hydrogen-containing gas discharged from the first heat exchanger. The separated gas phase is then fed to the vacuum pump, which may increase the regeneration efficiency of the adsorbent. A second heat exchanger cools the hydrogen-containing gas discharged from the vacuum pump and feeds the hydrogen-containing gas back to, for example, Tower A operating in the adsorption mode, which performs the purifying operation.

The purity of hydrogen gas generated by the purifying system is higher to at least 99%, at least 99.9%, or at least 99.97%. Accordingly, the hydrogen gas may be available as a source material for a fuel cell without an additional purification operation.

An example of the present disclosure provides a method and a system for purifying hydrogen-containing gas by reducing partial pressure of moisture in an adsorbent (e.g., activated carbons, zeolites, metal-organic frameworks (MOFs), etc.) when regenerating the adsorbent to reduce energy consumption, and by reducing a swing time between adsorption and desorption to improve purifying efficiency.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, there is provided a method for purifying hydrogen-containing gas through Temperature Vacuum Swing Adsorption (TVSA), which includes:
a purifying step for producing hydrogen by adsorbing internal moisture of hydrogen-containing gas using an adsorbent (e.g., activated carbons, zeolites, metal-organic frameworks (MOFs), etc.) (S10);
a pressure reducing step for reducing partial pressure of moisture adsorbed to the adsorbent (S20);
an adsorbent regenerating step for increasing a temperature of the adsorbent processed in the pressure reducing step and regenerating the adsorbent (S30); and
a cooling step for cooling the adsorbent regenerated (S40),
in which the adsorbent is filled in a plurality of towers (e.g., adsorption towers).

According to an example of the present disclosure, there is provided a system for purifying hydrogen-containing gas through Temperature Vacuum Swing Adsorption (TVSA), which includes:
a plurality of towers (e.g., adsorption towers) to be filled with an adsorbent to adsorb internal moisture of the hydrogen-containing gas to the adsorbent;
a heater connected to an adsorption tower to increase a temperature of the adsorbent and regenerate the adsorbent; and
a vacuum pump connected to the adsorption tower to reduce partial pressure of moisture in the adsorbent to increase regeneration efficiency of the adsorbent,
in which swing in the plurality of towers is adjusted by a plurality of valves.

As described above, according to the purifying system, the partial pressure of moisture in the adsorbent (e.g., activated carbons, zeolites, metal-organic frameworks (MOFs), etc.) may be reduced using the vacuum pump to reduce energy consumption, when the adsorbent is regenerated, and a swing time between adsorption and desorption may be reduced (e.g., by 50% or more) to improve purifying efficiency. In addition, according to the purifying system for the hydrogen-containing gas, excellent efficiency may be exhibited in hydrogen production by reusing, as a source material, the cleaning gas (e.g., hydrogen-rich gas, nitrogen gas, air, steam, carbon dioxide, or helium, etc.) used to regenerate the adsorbent.

According to the present disclosure, in the method for purifying the hydrogen-containing gas, the partial pressure of moisture in the adsorbent may be reduced when the adsorbent is regenerated to reduce the temperature when the adsorbent is regenerated, thereby reducing energy consumption, and the swing time between absorption and desorption may be reduced to exhibit excellent purifying efficiency (see FIG. 7). In addition, the cleaning gas may be reused as the source material to regenerate the adsorbent, thereby exhibiting excellent hydrogen production efficiency,

In addition, according to the present disclosure, in the system for purifying the hydrogen-containing gas, the internal pressure of the adsorption tower may be maintained to be lower using the vacuum pump during regenerating the adsorbent, thereby reducing the temperature necessary for regeneration such that energy consumption is reduced.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed:

1. A method for purifying hydrogen-containing gas, the method comprising:
producing hydrogen by removing at least a portion of moisture from hydrogen-containing gas, wherein the removed moisture is adsorbed by an adsorbent;
reducing partial pressure of the moisture adsorbed by the adsorbent;
after the reducing of the partial pressure, increasing a temperature of the adsorbent;
regenerating, based on the increasing the temperature, the adsorbent;
cooling the regenerated adsorbent; and
supplying the cooled adsorbent to at least one adsorption tower among a plurality of towers.

2. The method of claim 1, wherein the producing hydrogen is performed by the at least one adsorption tower among the plurality of towers, and
wherein the reducing the partial pressure, the increasing the temperature, the regenerating the adsorbent, and the cooling the regenerated adsorbent are performed in another tower different from the at least one adsorption tower.

3. The method of claim 1, wherein the increasing the temperature of the adsorbent comprises preheating the hydrogen-containing gas, and
wherein the regenerating the adsorbent comprises regenerating the adsorbent by discharging the preheated hydrogen-containing gas to the adsorbent.

4. The method of claim 3, further comprising:
cooling the discharged hydrogen-containing gas;
performing gas-liquid separation for the cooled hydrogen-containing gas to obtain a gas phase; and
supplying the gas phase to the adsorbent.

5. The method of claim 4, wherein the supplying the gas phase comprises:
cooling the gas phase; and
supplying the cooled gas phase to the adsorbent.

6. The method of claim 1, wherein the cooling the regenerated adsorbent comprises:
discharging the hydrogen-containing gas to the regenerated adsorbent.

7. The method of claim 6, further comprising:
cooling the discharged hydrogen-containing gas;
performing gas-liquid separation for the cooled hydrogen-containing gas to obtain a gas phase; and
supplying the gas phase to the adsorbent.

8. The method of claim 7, wherein the supplying the gas phase comprises:
cooling the gas phase; and
supplying the cooled gas phase to the adsorbent.

9. A system for purifying hydrogen-containing gas, the system comprising:
a plurality of towers configured to swing between adsorption mode of operation and desorption mode of operation, wherein at least one first tower of the plurality of towers operates in the adsorption mode for removing at least a portion of moisture from the hydrogen-containing gas, wherein the removed moisture is adsorbed by an adsorbent, and wherein at least one second tower of the plurality of towers operates in the desorption mode for regenerating a second adsorbent;
a heater connected to the at least one second tower for increasing a temperature of the second adsorbent to release the adsorbed moisture from the second adsorbent;
a vacuum pump connected to the at least one second tower for reducing partial pressure of the moisture in the second adsorbent; and
a plurality of valves configured to control the swing between the adsorption mode of operation and the desorption mode of operation.

10. The system of claim 9, wherein the at least one first tower is configured to perform a purification operation by adsorbing the at least the portion of moisture from the hydrogen-containing gas, and
wherein the at least one second tower is configured to regenerate the second adsorbent by removing at least a portion of the adsorbed moisture from the second adsorbent.

11. The system of claim 10, further comprising:
a first heat exchanger configured to cool the hydrogen-containing gas discharged from the at least one second tower, which regenerates the second adsorbent, wherein the first heat exchanger is placed between the vacuum pump and the plurality of towers.

12. The system of claim 11, further comprising:
a gas-liquid separator configured to:
perform gas-liquid separation for the hydrogen-containing gas to obtain a gas phase, wherein the hydrogen-containing gas is cooled and discharged from the first heat exchanger, and
supply the gas phase to the vacuum pump.

13. The system of claim 10, further comprising:
a second heat exchanger configured to:
cool the hydrogen-containing gas discharged from the vacuum pump, and
supply the cooled hydrogen-containing gas to the at least one first tower, which performs the purification operation.

14. The system of claim 10, wherein the at least one first tower operates in the desorption mode when the at least one second tower operate in the adsorption mode.

15. The system of claim 10, wherein the heater is configured to preheat the hydrogen-containing gas.

16. The system of claim 15, wherein the at least one second tower is configured to regenerate the second adsorbent by receiving the preheated hydrogen-containing gas.

17. The system of claim 10, further comprising:
a controller configured to control the plurality of valves to control swing time between the adsorption mode of the at least one first tower and the desorption mode of the at least one second tower.

18. The system of claim 9, wherein the vacuum pump is configured to reduce pressure in the at least one second tower to a target pressure that is less than atmospheric pressure.

19. The system of claim 12, wherein the gas-liquid separator is configured to separate condensed moisture from the hydrogen-containing gas before supplying the gas phase to the vacuum pump.

20. The system of claim 13, wherein the second heat exchanger is configured to control a temperature of the hydrogen-containing gas supplied to the at least one first tower.
